(19) United States
(12) Patent Application Publication
(10) Pub. No.: US 2026/0365006 A1
(43) Pub. Date: Nov. 19, 2026

(54) GLASS RUN AND WAIST SEAL

(71) Applicant: KINUGAWA RUBBER IND. Co., LTD., Chiba-shi, Chiba (JP)

(72) Inventors: Shigeru NAKAMURA, Chiba-shi, Chiba (JP); Yuuji SATOU, Chiba-shi, Chiba (JP)

(73) Assignee: KINUGAWA RUBBER IND. Co., LTD., Chiba-shi, Chiba (JP)

(21) Appl. No.: 19/470,488

(22) PCT Filed: Mar. 26, 2024
(86) PCT No.: PCT/JP2024/011824

§ 371 Date: Sep. 29, 2025

(30) Foreign Application Priority Data
Mar. 30, 2023 (JP) 2023-054570

(51) Int. Cl. B60J 10/76

(52) U.S. Cl. CPC B60J 10/76

(57) ABSTRACT

A glass run and a waist seal according to the present invention include an auxiliary member (23) and first and second auxiliary members (33) and (34) respectively, each of which corresponds to an auxiliary member formed of a dilatant fluid. It is therefore possible to ensure smooth up-and-down movement of a door glass (DG) within an allowable range of variation due to vehicle variations, and to reduce vibrations (amplitude) of the door glass (DG) and also quickly damp the vibrations (amplitude) in response to a large (fast) input that exceeds the allowable variation range.

### TECHNICAL FIELD

The present invention relates to a glass run and a waist seal which are applied to a door glass of a vehicle and serve to slide or hold the door glass.

### BACKGROUND ART

When describing an outline of a related art glass run GR, for instance, as illustrated in FIG. 17, the glass run GR includes an almost square bracket-shaped base portion 20 formed by a base bottom portion 201, an interior-side side wall portion 202 and an exterior-side side wall portion 203, and as a pair of seal lips, an interior-side seal lip 21 and an exterior-side seal lip 22 each extending from respective tip portions of both side walls 202 and 203 toward an inside of the base portion 20.

In addition, the related art glass run GR is provided, at a base bottom portion 201 side (a root side) of the interior-side side wall portion 202, with a sub lip 27 that faces the interior-side seal lip 21 in a free state and is sandwiched between the interior-side seal lip 21 and the interior-side side wall portion 202 in a sliding state of a door glass DG. That is, according to the related art glass run GR, when the door glass DG is significantly displaced to an interior side and the interior-side seal lip 21 is significantly bent and deformed, the interior-side seal lip 21 and the sub lip 27 cooperate with each other for supporting the door glass DG, thereby suppressing rattle of the door glass DG.

### CITATION LIST

### Patent Document

Patent Document 1: Japanese Patent No. JP5100029

### SUMMARY OF THE INVENTION

### Technical Problem

In the case of the related art glass run GR, however, in a case where a reaction force of the sub lip 27 is increased in order to suppress large backlash or fluttering (or rattle) of the door glass DG which occurs, for instance, when closing a door in a half-open state of the door glass DG, vibrations of the door glass DG can be effectively suppressed. On the other hand, when variations in the door glass DG in a vehicle width direction position occur due to variations in dimensions of a vehicle, a door panel, etc., the increase in reaction force of the sub lip 27 causes a sliding resistance (a sliding drag) of the door glass DG to be excessively high, and consequently, a raising-lowering characteristic of the door glass DG is lowered. Therefore, there is room for improvement in this point.

The present invention was made in view of the above technical problem. An object of the present invention is therefore to provide a glass run and a waist seal which are capable of obtaining a high vibration suppressing effect of the door glass while ensuring a good raising-lowering characteristic of the door glass.

### Solution to Problem

As one of aspects of the present invention, a glass run according to the present invention comprises: a base portion having a substantially square bracket-shaped cross section formed by a base bottom portion, an interior-side side wall portion, and an exterior-side side wall portion, both of which extend from both end portions, in a vehicle width direction, of the base bottom portion; an interior-side seal lip, and an exterior-side seal lip, which extend respective tip portions of both the side wall portions toward an inside of the base portion, and which are provided so as to be able to come into sliding-contact with a door glass that moves up and down inside the base portion along a longitudinal direction of both the side wall portions; and an auxiliary member which is formed of a dilatant fluid, and against which the interior-side seal lip abuts when the interior-side seal lip is bent and deformed toward an interior side of a vehicle.

As described above, the door glass can be supported by the auxiliary member formed of the dilatant fluid. Therefore, within a range of variation due to vehicle variations, the auxiliary member flexibly deforms. As a result, there is no risk that a sliding resistance (a sliding drag) of the door glass will excessively increase. Accordingly, smooth up-and-down movement of the door glass can be ensured.

On the other hand, when a displacement of the door glass exceeds the range of variation due to vehicle variations, the dilatant fluid constituting the auxiliary member instantaneously hardens, thereby instantly increasing a reaction force of the auxiliary member. It is therefore possible to reduce vibrations (amplitude) of the door glass and also quickly damp the vibrations (amplitude).

As a preferable aspect of the glass run according to the present invention, the auxiliary member is provided on an inner surface of the interior-side side wall portion, and a tip portion of the interior-side seal lip abuts against the auxiliary member when the interior-side seal lip is bent and deformed toward the interior side.

As described above, because of the configuration in which the tip portion of the interior-side seal lip abuts against the auxiliary member, in a state in which the interior-side seal lip is located at the exterior side, the interior-side seal lip does not abut against the auxiliary member, and only after the interior-side seal lip has been pressed toward the interior side by a predetermined amount, the interior-side seal lip abuts against the auxiliary member. Therefore, an initial reaction force of the interior-side seal lip can be reduced, and the sliding resistance (the sliding drag) of the door glass within the range of variation due to vehicle variations can be effectively decreased.

As a far preferable aspect of the glass run according to the present invention, the glass run further comprises a sub lip which is provided at and extends from an inner surface of the interior-side side wall portion toward the inside of the base portion, and against which the interior-side seal lip elastically abuts when the interior-side seal lip is bent and deformed toward the interior side, and the auxiliary member is provided on a surface, which faces the interior-side seal lip, of the sub lip, and the interior-side seal lip abuts against the auxiliary member when the interior-side seal lip is bent and deformed toward the interior side.

As described above, by providing the auxiliary member on the opposing surface of the sub lip to the interior-side seal lip and disposing the auxiliary member between the sub lip and the interior-side seal lip, it is possible to delay the change in reaction force of the sub lip. With this, there is no risk that the reaction force of the sub lip will significantly increase within a movable range based on the vehicle variations, in the vehicle width direction, of the door glass, thereby ensuring smooth up-and-down movement of the door glass.

On the other hand, when a large input that exceeds the movable range based on the vehicle variations, in the vehicle width direction, of the door glass is applied to the interior-side seal lip, since the dilatant fluid constituting the auxiliary member instantaneously hardens, the bending-deformation of the interior-side seal lip is directly transmitted to the sub lip via the auxiliary member. Therefore, the reaction force of the sub lip is instantly increased, thereby accelerating the change in the reaction force of the sub lip. It is thus possible to reduce the vibrations (amplitude) of the door glass and also to quickly damp the vibrations (amplitude).

Furthermore, according to the present invention, since the sub lip is provided at the base portion, it is possible to generate the reaction force by the interior-side seal lip and the sub lip. With this, although there is a possibility that the vibrations (amplitude) of the door glass will increase by an amount of bending-deformation of the sub lip, since the reaction force of the sub lip acts in addition to the interior-side seal lip, the vibrations of the door glass can be damped and converged more quickly.

In addition, as a far preferable aspect of the glass run according to the present invention, the auxiliary member is provided on an inner surface of the interior-side side wall portion, and a root portion of the interior-side seal lip abuts against the auxiliary member when the interior-side seal lip is bent and deformed toward the interior side.

As described above, since the auxiliary member is disposed at the root portion of the interior-side seal lip, it is possible to increase an initial reaction force of the interior-side seal lip. At this time, although the initial reaction force of the interior-side seal lip is increased, when the door glass moves up and down, the dilatant fluid constituting the auxiliary member flexibly (gently) deforms. Therefore, there is no risk that the reaction force will significantly increase within the movable range based on the vehicle variations, in the vehicle width direction, of the door glass, thereby ensuring smooth up-and-down movement of the door glass.

On the other hand, when a large input that exceeds the movable range based on the vehicle variations, in the vehicle width direction, of the door glass is applied to the interior-side seal lip, since the dilatant fluid constituting the auxiliary member instantaneously hardens, thereby instantly increasing the reaction force of the auxiliary member then reducing the vibrations (amplitude) of the door glass. In addition, by the increase in the initial reaction force, as a merit, in particular, initial movement of the vibration of the door glass can be effectively suppressed.

Additionally, as one of aspects of the present invention, a waist seal according to the present invention comprises: a mounting base portion attached to an interior-side door panel or a door trim that covers the interior-side door panel; a seal lip provided at and extending from the mounting base portion toward an exterior side of a vehicle, and coming into sliding-contact with a door glass to seal a gap between the interior-side door panel or the door trim and the door glass; and an auxiliary member formed of a dilatant fluid, and provided on an exterior-side side surface of the mounting base portion so as to face the seal lip, wherein the seal lip abuts against the auxiliary member when the seal lip is bent and deformed toward an interior side of the vehicle.

As described above, the door glass can be supported by the auxiliary member formed of the dilatant fluid. Therefore, within a range of variation due to vehicle variations, the auxiliary member flexibly deforms. As a result, there is no risk that a sliding resistance (a sliding drag) of the door glass will excessively increase. Accordingly, smooth up-and-down movement of the door glass can be ensured.

On the other hand, when a displacement of the door glass exceeds the range of variation due to vehicle variations, the dilatant fluid constituting the auxiliary member instantaneously hardens, thereby instantly increasing a reaction force of the auxiliary member. It is therefore possible to reduce vibrations (amplitude) of the door glass and also quickly damp the vibrations (amplitude).

As a preferable aspect of the waist seal according to the present invention, a plurality of seal lips are provided on the exterior-side side surface, which faces the door glass, of the mounting base portion along an up-and-down movement direction of the door glass, and a plurality of auxiliary members are provided so as to face the respective seal lips, and when the seal lips are bent and deformed toward the interior side, the seal lips abut against the auxiliary members.

As described above, the plurality of auxiliary members are provided so as to face the respective seal lips, and the reaction force of each of the seal lips upon being bent and deformed can be adjusted by the plurality of auxiliary members. It is therefore possible to ensure smooth up-and-down movement of the door glass without significantly increasing the sliding resistance (the sliding drag) of each seal lip to the door glass, by each of the auxiliary members.

On the other hand, when a displacement of the door glass exceeds the range of variation due to vehicle variations, the dilatant fluid constituting each of the auxiliary member instantaneously hardens, thereby instantly increasing the reaction force of each auxiliary member. It is therefore possible to effectively reduce the vibrations (amplitude) of the door glass and also quickly damp the vibrations (amplitude).

### Effects of Invention

According to the present invention, the door glass is supported by the auxiliary member formed of the dilatant fluid. Therefore, within the range of variation due to vehicle variations, the auxiliary member flexibly deforms, thereby ensuring smooth up-and-down movement of the door glass. On the other hand, when a displacement of the door glass exceeds the range of variation due to vehicle variations, the dilatant fluid constituting the auxiliary member instantaneously hardens, thereby reducing the vibrations (amplitude) of the door glass and also quickly damping the vibrations (amplitude).

### BRIEF DESCRIPTION OF THE DRAWINGS

FIG. 1 is a front view of a door to which a glass run according to the present invention is mounted.

FIG. 2 is a drawing showing a first embodiment of the glass run according to the present invention, which is a cross-sectional view taken along an A-A line of FIG. 1.

FIG. 3 is a drawing showing a first embodiment of a waist seal according to the present invention, which is a cross-sectional view taken along a B-B line of FIG. 1.

FIGS. 4A to 4D are drawings showing states of the glass run when a door glass vibrates. FIG. 4A is a cross-sectional view of the glass run, showing a state in which the door glass is located closest to a vehicle exterior side. FIG. 4B is a cross-sectional view of the glass run, showing a state in which the door glass is located at a center. FIG. 4C is a cross-sectional view of the glass run, showing a state in which the door glass is located closest to a vehicle interior side within an allowable variation range. FIG. 4D is a cross-sectional view of the glass run, showing a state in which the door glass is located closest to the vehicle interior side.

FIG. 5 is a graph showing reaction force characteristics of the glass run shown in FIG. 2.

FIG. 6 is a graph showing amplitude and attenuation characteristics of the glass run shown in FIG. 2.

FIG. 7 is a drawing showing a modified example of the first embodiment of the glass run according to the present invention, which is a cross-sectional view taken along an A-A line of FIG. 1.

FIGS. 8A to 8D are drawings showing states of the glass run when the door glass vibrates. FIG. 8A is a cross-sectional view of the glass run, showing a state in which the door glass is located closest to a vehicle exterior side. FIG. 8B is a cross-sectional view of the glass run, showing a state in which the door glass is located at a center. FIG. 8C is a cross-sectional view of the glass run, showing a state in which the door glass is located closest to a vehicle interior side within an allowable variation range. FIG. 8D is a cross-sectional view of the glass run, showing a state in which the door glass is located closest to the vehicle interior side.

FIG. 9 is a graph showing reaction force characteristics of the glass run shown in FIG. 7.

FIG. 10 is a drawing showing a second embodiment of the glass run according to the present invention, which is a cross-sectional view taken along an A-A line of FIG. 1.

FIGS. 11A to 11D are drawings showing states of the glass run when the door glass vibrates. FIG. 11A is a cross-sectional view of the glass run, showing a state in which the door glass is located closest to a vehicle exterior side. FIG. 11B is a cross-sectional view of the glass run, showing a state in which the door glass is located at a center. FIG. 11C is a cross-sectional view of the glass run, showing a state in which the door glass is located closest to a vehicle interior side within an allowable variation range. FIG. 11D is a cross-sectional view of the glass run, showing a state in which the door glass is located closest to the vehicle interior side.

FIG. 12 is a graph showing reaction force characteristics of the glass run shown in FIG. 10.

FIG. 13 is a graph showing amplitude and attenuation characteristics of the glass run shown in FIG. 10.

FIG. 14 is a drawing showing a second embodiment of the waist seal according to the present invention, which is a cross-sectional view taken along a B-B line of FIG. 1.

FIGS. 15A to 15D are drawings showing states of the glass run when the door glass vibrates. FIG. 15A is a cross-sectional view of the glass run, showing a state in which the door glass is located closest to a vehicle exterior side. FIG. 15B is a cross-sectional view of the glass run, showing a state in which the door glass is located closest to the vehicle exterior side within an allowable variation range. FIG. 15C is a cross-sectional view of the glass run, showing a state in which the door glass is located at a center. FIG. 15D is a cross-sectional view of the glass run, showing a state in which the door glass is located closest to a vehicle interior side.

FIG. 16 is a graph showing reaction force characteristics of a related art glass run using an auxiliary member made of a sponge material.

FIGS. 17A to 17D are drawings showing states of the glass run when the door glass vibrates. FIG. 17A is a cross-sectional view of the glass run, showing a state in which the door glass is located closest to a vehicle exterior side. FIG. 17B is a cross-sectional view of the glass run, showing a state in which the door glass is located at a center. FIG. 17C is a cross-sectional view of the glass run, showing a state in which the door glass is located at a vehicle interior side with respect to an allowable variation range and a sub lip abuts against an interior-side side wall portion of a base portion. FIG. 17D is a cross-sectional view of the glass run, showing a state in which the door glass is located closest to the vehicle interior side.

FIG. 18 is a graph showing reaction force characteristics of a related art glass run using the sub lip.

### EMBODIMENTS FOR CARRYING OUT THE INVENTION

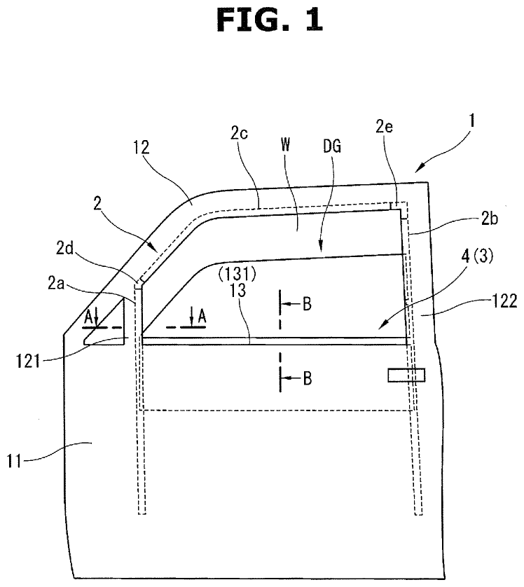

Embodiments of a glass run and a waist seal according to the present invention which are applied to a front door (hereinafter, simply referred to as “door”) 1 for a vehicle will be described in detail below with reference to the drawings. In each embodiment, for convenience of description, an upper side of FIG. 1, which corresponds to an upper side in a vertical direction, is defined as “upper”, and a lower side of FIG. 1, which corresponds to a lower side in the vertical direction, is defined as “lower”, with the top and bottom of a vehicle body mounting state being a reference.

### Configuration of Door

FIG. 1 is a front view of a door 1 to which a glass run 2 according to the present invention is mounted.

As illustrated in FIG. 1, the door 1 includes a door body 11, and a door sash 12 connected to the door body 11 and extending upward in an arch shape from a door waist portion 13 of the door body 11. A glass opening W is formed between the door body 11 and the door sash 12, and the glass run 2 is attached to a peripheral edge portion of this glass opening W.

The glass run 2 includes a pair of vertical side portions 2a and 2b formed by extrusion molding, and an upper side portion 2c formed by extrusion molding and connecting both the vertical side portions 2a and 2b. The vertical side portions 2a and 2b and the upper side portion 2c are connected by respective molded portions 2d and 2e. The glass run 2 serves to guide a door glass DG when the door glass DG is raised and lowered (moves up and down), to absorb vibrations of the door glass DG during travel of the vehicle and when the door 1 is closed, and to ensure watertight and airtight sealing between the door glass DG and the door sash 12.

Further, at the door waist portion 13 of the door body 11, as a pair of waist seals, an interior-side waist seal (corresponding to a waist seal according to the present invention) 3 and an exterior-side waist seal 4 are arranged on an interior side and an exterior side of a door waist opening 130 so as to face each other with respect to the door glass DG.

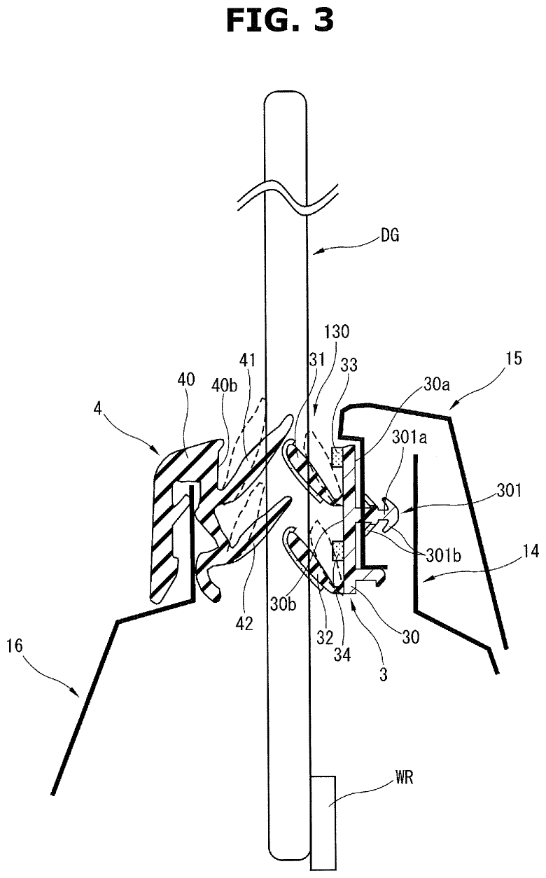

The door glass DG is disposed so as to be able to come out from the door waist opening 130 that is open upward, and so as to be able to move up and down along vertical side portions 121 and 122, which extend in an up-and-down direction, of the door sash 12. The door glass DG is raised and lowered (moves up and down) based on power output from a window regulator (see a reference symbol WR in FIG. 3) that is mounted inside the door body 11.

### First Embodiment

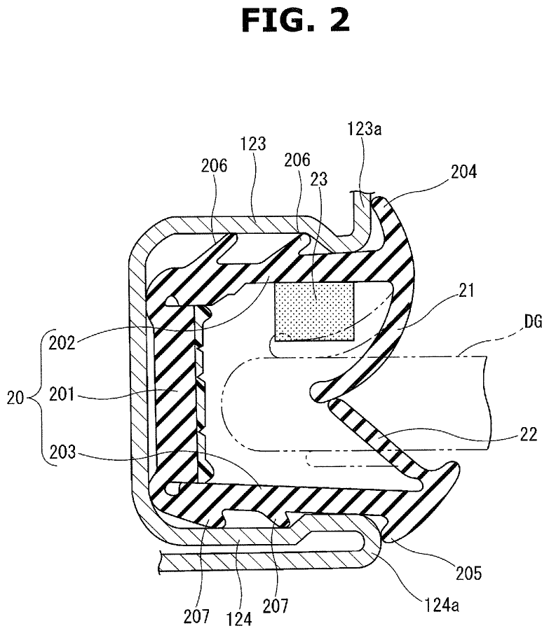

FIGS. 2 to 6 illustrate a first embodiment of the glass run and the waist seal according to the present invention.

### Configuration of Glass Run

FIG. 2 is a cross-sectional view of the vertical side portion 121 of the glass run 2 according to the first embodiment of the present invention, which is cut along an A-A line of FIG. 1.

As illustrated in FIG. 2, the vertical side portion 121 of the door sash 12 has a substantially square bracket-shaped cross section formed by integrally bending a bottom wall 121a, an interior-side side wall 121b and an exterior-side side wall 121c. The interior-side side wall 121b is connected to a door inner panel (not shown) that is an interior-side door panel. The exterior-side side wall 121c is connected to a door outer panel (not shown) that is an exterior-side door panel.

The glass run 2 has a substantially square bracket-shaped cross section (a substantially square bracket-shaped cross-sectional surface) orthogonal to a longitudinal direction of the glass run 2. The glass run 2 is formed into an integral, long, continuous shape by extrusion-molding a thermoplastic resin such as a thermoplastic elastomer (TPE). The glass run 2 includes a base portion 20 that is attached to the door sash 12, and as a pair of seal lips, an interior-side seal lip 21 and an exterior-side seal lip 22 that extend toward the inside of the base portion 20 so as to face each other and that elastically contact an interior-side side surface and an exterior-side side surface of the door glass DG respectively.

The base portion 20 includes a base bottom portion 201 that is fixed to a bottom surface of the door sash, and an interior-side side wall portion 202 and an exterior-side side wall portion 203 that are provided so as to be bent from an interior-side end portion and an exterior-side end portion of the base bottom portion 201 respectively and that substantially linearly extend, with these portions 201, 202 and 203 being integrally formed. It is noted that the base bottom portion 201 is made of a material that is different from the interior-side seal lip 21 and the exterior-side seal lip 22, more specifically, is made of a thermoplastic resin having a relatively higher rigidity than the interior-side seal lip 21 and the exterior-side seal lip 22.

The interior-side side wall portion 202 includes an interior-side molding lip 204 provided at and protruding from an outer side of a tip portion of the interior-side side wall portion 202 in a folded manner toward an opposite side to the interior-side seal lip 21, and elastically contacting a flange portion 123a of an interior-side side wall 123 of the door sash 12. In addition, the interior-side side wall portion 202 is provided, on an outer surface at the base bottom portion 201 side thereof, with an interior-side holding lip(s) 206 that holds the flange portion 123a of the interior-side side wall 123 of the door sash 12 in a grasping state in cooperation with the interior-side molding lip 204.

The exterior-side side wall portion 203 includes an exterior-side molding lip 205 provided at and protruding from an outer side of a tip portion of the exterior-side side wall portion 203 in a folded manner toward an opposite side to the exterior-side seal lip 22, and elastically contacting a flange portion 124a of an exterior-side side wall 124 of the door sash 12. In addition, the exterior-side side wall portion 203 is provided, on an outer surface at the base bottom portion 201 side thereof, with an exterior-side holding lip(s) 207 that holds the flange portion 124a of the exterior-side side wall 124 of the door sash 12 in a grasping state in cooperation with the exterior-side molding lip 205.

The interior-side seal lip 21 is formed in a folded state from an inner side of a tip portion of the interior-side side wall portion 202, and extends in a curved shape toward the base bottom portion 201 side. Here, the exterior-side seal lip 22 is formed so as to be shorter than the interior-side seal lip 21. On the other hand, the exterior-side seal lip 22 is formed in a folded state from an inner side of a tip portion of the exterior-side side wall portion 203 so as to face the interior-side seal lip 21, and substantially linearly extends toward the base bottom portion 201 side. When the door glass DG is lowered, as shown by solid lines in FIG. 2, the interior-side seal lip 21 and the exterior-side seal lip 22 abut and face each other. On the other hand, when the door glass DG is raised, as shown by virtual lines in FIG. 2, the interior-side seal lip 21 and the exterior-side seal lip 22 are pushed away (pushed aside) by the door glass DG, and come into elastic contact with the inner surface and the outer surface of the door glass DG respectively.

Furthermore, the interior-side side wall portion 202 is provided, on an inner surface thereof, with an auxiliary member 23 with which a tip portion of the interior-side seal lip 21, which has been pushed to the interior side by the door glass DG when the door glass DG is raised, can come into elastic contact. This auxiliary member 23 is formed integrally with the interior-side side wall portion 202 using a dilatant fluid. The auxiliary member 23 is continuously provided along a longitudinal direction of the interior-side side wall portion 202, and is formed so as to have a substantially rectangular cross-sectional surface in a free state. It is noted that as a matter of course, any cross-sectional shape of the auxiliary member 23 can be adopted according to specifications of the glass run 2 (for instance, a shape of the interior-side seal lip 21, reaction force characteristics required of the auxiliary member 23, etc.). Furthermore, the auxiliary member 23 could be formed integrally with the interior-side side wall portion 202 by extrusion molding, or the auxiliary member 23 may be fixed to the interior-side side wall portion 202 by a fixing means such as vulcanization adhesion.

### Configuration of Waist Seal

FIG. 3 is a cross-sectional view showing the first embodiment of the waist seal (the interior-side waist seal 3) according to the present invention, which is cut along a B-B line of FIG. 1.

As illustrated in FIG. 3, the interior-side waist seal 3, corresponding to the waist seal according to the present invention, is attached to a door trim 15 that covers a door inner panel 14 of the door panel forming the door waist opening 130. On the other hand, the exterior-side waist seal 4, which is paired with the interior-side waist seal 3 and which seals a gap between a door outer panel 16 and the door glass DG, is attached to the door outer panel 16 forming the door waist opening 130.

The interior-side waist seal 3 includes a mounting base portion 30 serving to mount the interior-side waist seal 3 to the door trim 15, and a pair of first and second seal lips 31 and 32 formed in two upper and lower stages and protruding substantially parallel to each other from the mounting base portion 30, with these portion and lips 30, 31 and 32 being integrally formed.

The mounting base portion 30 is substantially formed into a plate shape with a synthetic resin material that is relatively hard in comparison with a rubber material. The mounting base portion 30 is attached to the door trim 15 via a clip portion 301 which is formed at and protrudes from an inner surface 30a that is a side surface opposite to the first and second seal lips 31 and 32 and that faces the door trim 15. More specifically, a substantially hook-shaped locking protrusion(s) 301b provided on a tip side of a shaft portion 301a of the clip portion 301 is engaged with a hole edge portion of an engagement hole (not shown) that penetrates the door trim 15, then the mounting base portion 30 is attached and fixed to the door trim 15 so that the door trim 15 is sandwiched between the mounting base portion 30 and the locking protrusion 301b of the clip portion 301.

Each of the first seal lip 31 and the second seal lip 32 is formed of a relatively soft foamed sponge rubber-based material, and is provided on an outer surface 30b of the mounting base portion 30 so as to extend obliquely upward from the outer surface 30b. In a free state in which the door glass DG is in a lowered state, as shown by solid lines in FIG. 3, the first seal lip 31 and the second seal lip 32 face a first seal lip 41 and a second seal lip 42 of the exterior-side waist seal 4 respectively in a non-contact state. On the other hand, in a bending deformation state in which the door glass DG is in a raised state, as shown by virtual lines in FIG. 3, the first seal lip 31 and the second seal lip 32 elastically contact the inner surface of the door glass DG by being pushed by the door glass DG.

Furthermore, the mounting base portion 30 is provided, at a position, facing an inner surface of a tip portion of the first seal lip 31, on the outer surface 30b of the mounting base portion 30, with a first auxiliary member 33 with which the tip portion of the first seal lip 31, which has been pushed to the interior side by the door glass DG when the door glass DG is raised, can come into elastic contact. Likewise, the mounting base portion 30 is provided, at a position, facing an inner surface of a tip portion of the second seal lip 32, on the outer surface 30b of the mounting base portion 30, with a second auxiliary member 34 with which the tip portion of the second seal lip 32, which has been pushed to the interior side by the door glass DG when the door glass DG is raised, can come into elastic contact.

Similar to the auxiliary member 23, the first auxiliary member 33 and the second auxiliary member 34 are each continuously provided along a longitudinal direction of the mounting base portion 30 using the same dilatant fluid, and are each formed integrally with the mounting base portion 30 with vulcanization adhesion etc. The first auxiliary member 33 and the second auxiliary member 34 are each formed so as to have a substantially rectangular cross-sectional surface in a free state. It is noted that any cross-sectional shape of the first auxiliary member 33 and the second auxiliary member 34 can be adopted according to specifications of the interior-side waist seal 3 (for instance, shapes of the first seal lip 31 and the second seal lip 32, reaction force characteristics required of the first auxiliary member 33 and the second auxiliary member 34, etc.).

The exterior-side waist seal 4 includes a mounting base portion 40 serving to mount the exterior-side waist seal 4 to the door outer panel 16, and the pair of first and second seal lips 41 and 42 formed in two upper and lower stages and protruding substantially parallel to each other from the mounting base portion 40, with these portion and lips 40, 41 and 42 being integrally formed.

The mounting base portion 40 is formed of a hard solid rubber-based material such as EPDM. The mounting base portion 40 has an inverted U-shaped cross section, and is attached to the door outer panel 16 by sandwiching an upper end portion of the door outer panel 16.

Each of the first seal lip 41 and the second seal lip 42 is formed of a foamed sponge rubber-based material that is softer than the solid rubber-based material forming the mounting base portion 40, by extrusion molding. Each of the first seal lip 41 and the second seal lip 42 is provided on an inner surface 40b of the mounting base portion 40 so as to extend obliquely upward from the inner surface 40b. In a free state in which the door glass DG is in a lowered state, as shown by solid lines in FIG. 3, the first seal lip 41 and the second seal lip 42 face the first seal lip 31 and the second seal lip 32 of the interior-side waist seal 3 respectively in a non-contact state. On the other hand, in a bending deformation state in which the door glass DG is in a raised state, as shown by virtual lines in FIG. 3, the first seal lip 41 and the second seal lip 42 elastically contact the outer surface of the door glass DG by being pushed by the door glass DG.

### Working and Effect of the Present Embodiment

In the case of the related art glass run GR, rattle of the door glass DG is suppressed by assisting (or supporting) the interior-side seal lip 21, for instance, by the following configuration.

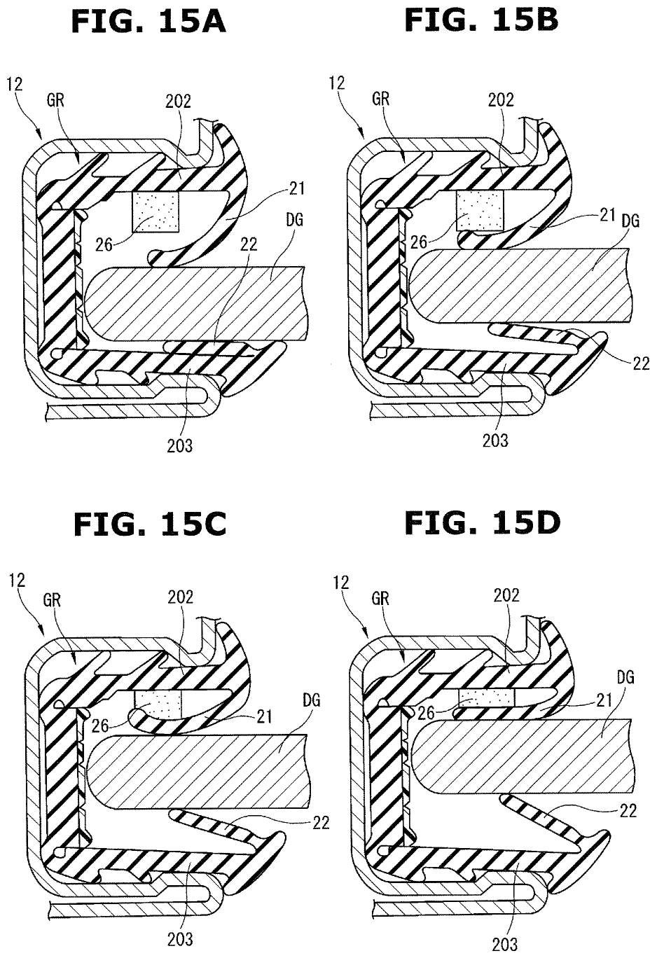

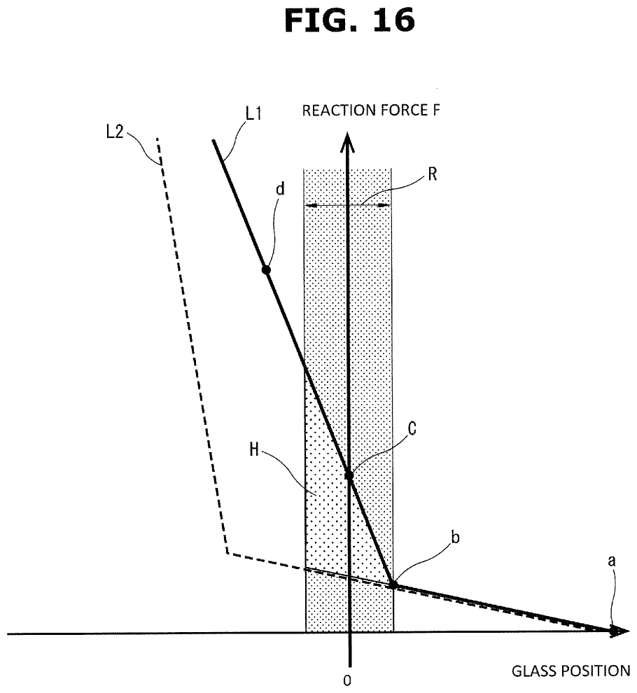

FIGS. 15A to 15D are cross-sectional views showing states of the related art glass run GR when the door glass DG vibrates. FIG. 15A shows a state in which the door glass DG is located closest to the exterior side in a vehicle width direction. FIG. 15B shows a state in which the door glass DG is located closest to the exterior side within an allowable variation range R in the vehicle width direction. FIG. 15C shows a state in which the door glass DG is located at a center of the allowable variation range R in the vehicle width direction. FIG. 15D shows a state in which the door glass DG is located closest to the interior side in the vehicle width direction. FIG. 16 is a graph showing reaction force characteristics of the related art glass run GR to which an auxiliary member 26 is added. A point a indicates the state of FIG. 15A, a point b indicates the state of FIG. 15B, a point c indicates the state of FIG. 15C, and a point d indicates the state of FIG. 15D. Here, the allowable variation range R shown in FIG. 16 indicates a range that can allow (tolerate) variations in the door glass DG when the door glass DG moves up and down, including manufacturing errors and installation errors of the door glass DG. Furthermore, a solid line L1 shown in FIG. 16 indicates reaction force characteristics of the interior-side seal lip 21 in a state in which the auxiliary member 26 is added. A virtual line L2 indicates reaction force characteristics of the interior-side seal lip 21 in a state in which the auxiliary member 26 is not added.

In the case of the related art glass run GR, as a configuration of the rattle suppression of the door glass DG, for instance, as shown in FIGS. 15A to 15D, the glass run GR is provided, on an inner surface of the interior-side side wall portion 202, with the auxiliary member 26 made of a sponge material, with which an inner surface of a tip portion of the interior-side seal lip 21, having been pushed to the interior side by the door glass DG when the door glass DG is raised, comes into elastic contact, and which assists in supporting sliding-contact of the interior-side seal lip 21 with the door glass DG.

In the case of this configuration, by adding the auxiliary member 26, until the interior-side seal lip 21 abuts against the auxiliary member 26 (the point a to the point b in FIG. 16), a reaction force F of the interior-side seal lip 21 gently increases due to the reaction force of the interior-side seal lip 21 alone. After the interior-side seal lip 21 abuts against the auxiliary member 26 (the point b to the point d in FIG. 16), the reaction force F of the interior-side seal lip 21 significantly increases due to a resultant force (a combined force) of the interior-side seal lip 21 and the auxiliary member 26. In this manner, by adding the auxiliary member 26, as compared with a case where the auxiliary member 26 is not added, a timing of increase in the reaction force F of the interior-side seal lip 21 is advanced, thereby suppressing the rattle of the door glass DG early from a state in which the door glass DG is located within the allowable variation range R.

However, on the other hand, the addition of the auxiliary member 26 made of the sponge material causes the reaction force F of the interior-side seal lip 21 to increase from the state in which the door glass DG is located within the allowable variation range R (see a hatching part H in FIG. 16). Because of this, for instance, when variations in the door glass DG in the vehicle width direction position occur due to variations in dimensions of a vehicle, a door panel, etc., the increase in reaction force F of the auxiliary member 26 causes a sliding resistance (a sliding drag) of the door glass DG to be excessively high, and consequently, a raising-lowering characteristic of the door glass DG is lowered. Therefore, there is room for improvement in this point.

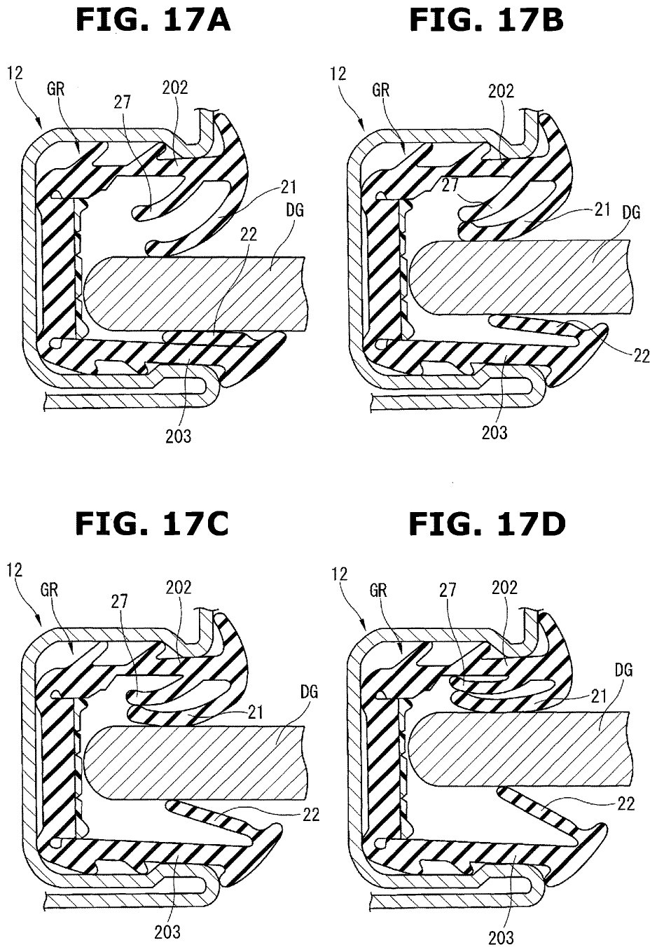

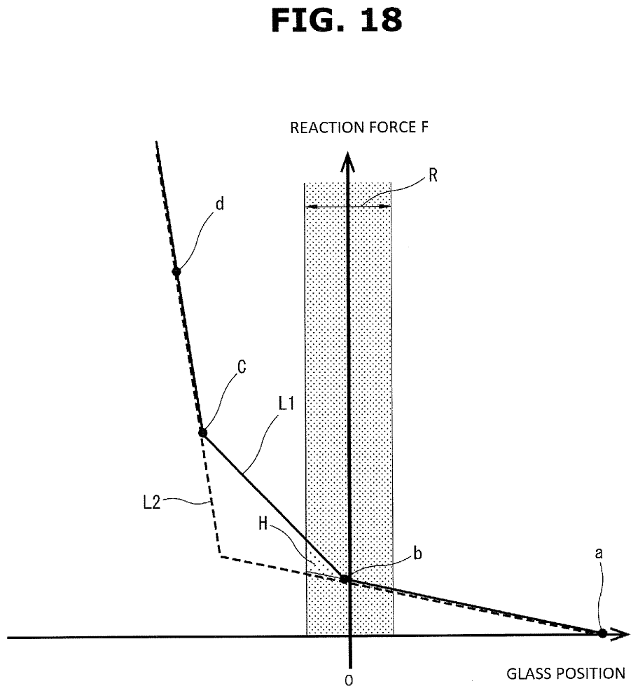

FIGS. 17A to 17D are cross-sectional views showing states of the related art glass run GR when the door glass DG vibrates. FIG. 17A shows a state in which the door glass DG is located closest to the exterior side in the vehicle width direction. Fig. 17B shows a state in which the door glass DG is located at a center of the allowable variation range R in the vehicle width direction. FIG. 17C shows a state in which the door glass DG is located at the interior side with respect to the allowable variation range R in the vehicle width direction. FIG. 17D shows a state in which the door glass DG is located closest to the interior side in the vehicle width direction. FIG. 18 is a graph showing reaction force characteristics of the related art glass run GR to which a sub lip 27 is added. A point a indicates the state of FIG. 17A, a point b indicates the state of FIG. 17B, a point c indicates the state of FIG. 17C, and a point d indicates the state of FIG. 17D. Here, the allowable variation range R shown in FIG. 18 indicates a range that can allow (tolerate) variations in the door glass DG when the door glass DG moves up and down, including manufacturing errors and installation errors of the door glass DG. Furthermore, a solid line L1 shown in FIG. 18 indicates reaction force characteristics of the interior-side seal lip 21 in a state in which the sub lip 27 is added. A virtual line L2 indicates reaction force characteristics of the interior-side seal lip 21 in a state in which the sub lip 27 is not added.

In the case of the related art glass run GR, as another configuration of the rattle suppression of the door glass DG, for instance, as shown in FIGS. 17A to 17D, the glass run GR is provided, on an inner surface of the interior-side side wall portion 202, with the sub lip 27 with which an inner surface of a tip portion of the interior-side seal lip 21, having been pushed to the interior side by the door glass DG when the door glass DG is raised, comes into elastic contact, and which assists in supporting sliding-contact of the interior-side seal lip 21 with the door glass DG.

In the case of this configuration, by adding the sub lip 27, until the interior-side seal lip 21 abuts against the sub lip 27 (the point a to the point b in FIG. 18), a reaction force F of the interior-side seal lip 21 gently increases due to the reaction force of the interior-side seal lip 21 alone. Until the sub lip 27 abuts against the interior-side side wall portion 202 after the interior-side seal lip 21 abuts against the sub lip 27 (the point b to the point c in FIG. 18), the reaction force F of the interior-side seal lip 21 increases by one step due to the sub lip 27. After the sub lip 27 abuts against the interior-side side wall portion 202 (the point c to the point d in FIG. 18), the reaction force F of the interior-side seal lip 21 further increases by one step due to a resultant force (a combined force) of the interior-side seal lip 21 and the sub lip 27. In this manner, by adding the sub lip 27, as compared with a case where the sub lip 27 is not added, a timing of increase in the reaction force F of the interior-side seal lip 21 is advanced, thereby suppressing the rattle of the door glass DG early from a state in which the door glass DG is located within the allowable variation range R. In addition, in the case of this configuration, since the reaction force characteristics of the interior-side seal lip 21 increase in two steps, in comparison with the case where the auxiliary member 26 is added, it is possible to suppress the increase in the reaction force F of the interior-side seal lip 21.

However, on the other hand, the addition of the sub lip 27 causes the reaction force F of the interior-side seal lip 21 to not a little increase from the state in which the door glass DG is located within the allowable variation range R (see a hatching part H in FIG. 18). Because of this, even in this configuration, for instance, when variations in the door glass DG in the vehicle width direction position occur due to variations in dimensions of a vehicle, a door panel, etc., the increase in reaction force F of the sub lip 27 causes a sliding resistance (a sliding drag) of the door glass DG to be increased, and consequently, a raising-lowering characteristic of the door glass DG is not a little lowered. Therefore, there is room for improvement in this point.

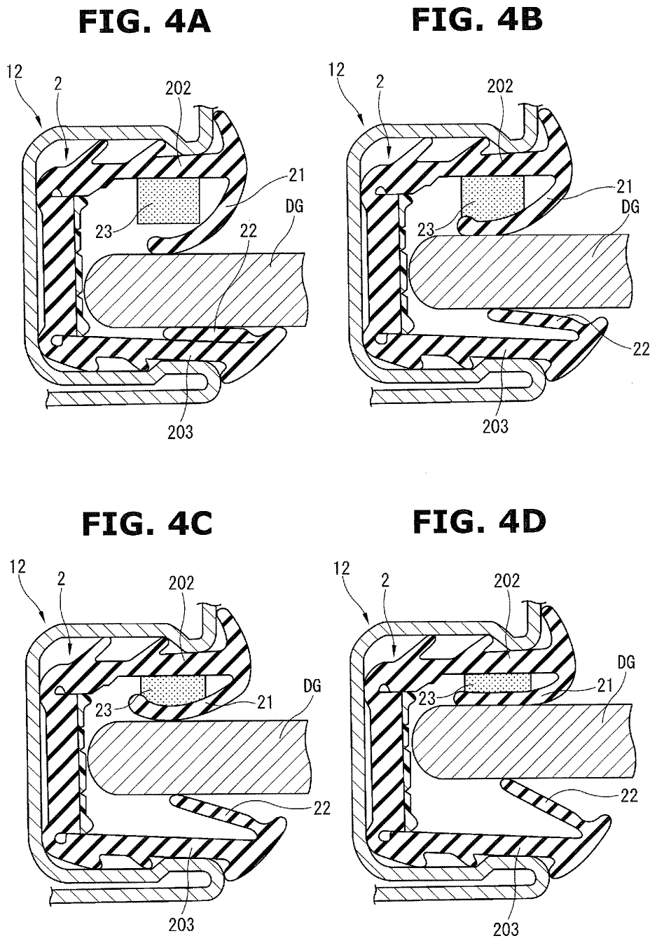

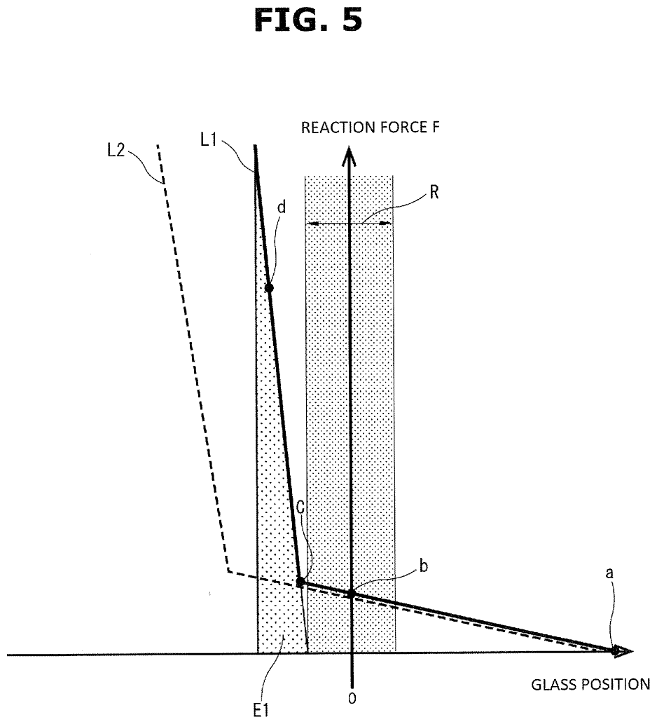

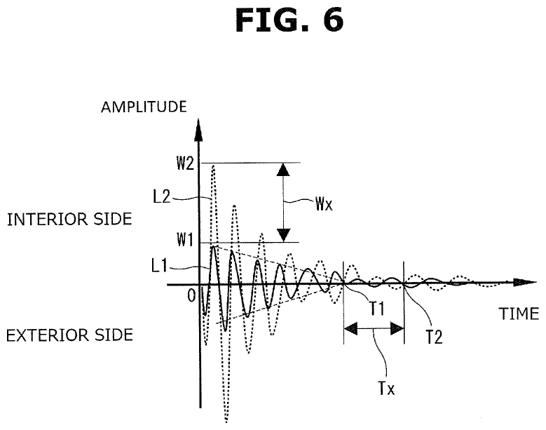

FIGS. 4A to 4D are cross-sectional views showing states of the glass run GR according to the present embodiment when the door glass DG vibrates. FIG. 4A shows a state in which the door glass DG is located closest to the exterior side in the vehicle width direction. FIG. 4B shows a state in which the door glass DG is located at a center of the allowable variation range R in the vehicle width direction. FIG. 4C shows a state in which the door glass DG is located closest to the interior side within the allowable variation range R in the vehicle width direction. FIG. 4D shows a state in which the door glass DG is located closest to the interior side in the vehicle width direction. FIG. 5 is a graph showing reaction force characteristics of the glass run GR according to the present embodiment. A point a indicates the state of FIG. 4A, a point b indicates the state of FIG. 4B, a point c indicates the state of FIG. 4C, and a point d indicates the state of FIG. 4D. Here, the allowable variation range R shown in FIG. 5 indicates a range that can allow (tolerate) variations in the door glass DG when the door glass DG moves up and down, including manufacturing errors and installation errors of the door glass DG. Furthermore, a solid line L1 shown in FIG. 5 indicates reaction force characteristics of the interior-side seal lip 21 according to the present embodiment. A virtual line L2 indicates reaction force characteristics of the interior-side seal lip 21 in a state in which the auxiliary member 23 is not added. FIG. 6 is a graph showing amplitude and attenuation characteristics of the glass run GR shown in FIG. 2. A solid line L1 shown in FIG. 6 indicates attenuation characteristics of the interior-side seal lip 21 according to the present embodiment. A virtual line L2 indicates attenuation characteristics of the interior-side seal lip 21 in a state in which the auxiliary member 23 is not added.

As illustrated in FIGS. 4A to 4D, the glass run GR according to the present embodiment supports the door glass DG by the auxiliary member 23 formed of the dilatant fluid. Therefore, as illustrated in FIG. 5, within the allowable range R of variation due to vehicle variations (the point a to the point c in FIG. 5), the dilatant fluid that constitutes the auxiliary member 23 flexibly deforms. As a result, there is no risk that the sliding resistance (the sliding drag) of the door glass DG will excessively increase. Accordingly, smooth up-and-down movement of the door glass DG can be ensured.

On the other hand, for a large (fast) input that causes a displacement of the door glass DG to exceed the allowable variation range R (the point d in FIG. 5), the dilatant fluid constituting the auxiliary member 23 instantaneously hardens, thereby instantly increasing the reaction force F of the interior-side seal lip 21. As a result, as illustrated in FIG. 6, the glass run GR according to the present embodiment, which is indicated by the solid line L1, can reduce vibrations (amplitude) of the door glass DG by a difference Wx between an amplitude W1 of L1 and an amplitude W2 of L2, as compared with the related art glass run GR indicated by the virtual line L2. Furthermore, since the amplitude W1 is reduced, a convergence time T1 of the amplitude W1 can also be shortened by a difference Tx between the convergence time T1 of L1 and a convergence time T2 of L2.

As described above, the glass run GR according to the present embodiment can ensure smooth up-and-down movement of the door glass DG within the allowable variation range R, and can reduce the vibrations (amplitude) of the door glass DG and also quickly damp the vibrations (amplitude) in response to a large (fast) input that exceeds the allowable variation range R, by the auxiliary member 23 formed of the dilatant fluid.

In addition, in the present embodiment, as illustrated in FIG. 4, the auxiliary member 23 is provided on the inner surface of the interior-side side wall portion 202, and when the interior-side seal lip 21 is bent and deformed toward the interior side, the tip portion of the interior-side seal lip 21 abuts against the auxiliary member 23.

With this configuration, in a state in which the interior-side seal lip 21 is located at the exterior side, the interior-side seal lip 21 does not abut against the auxiliary member 23. In other words, in the case of the present embodiment, the interior-side seal lip 21 abuts against the auxiliary member 23 only after the interior-side seal lip 21 has been pressed toward the interior side by a predetermined amount. Therefore, an initial reaction force of the interior-side seal lip 21 can be reduced, and the sliding resistance (the sliding drag) of the door glass DG within the allowable variation range R can be effectively decreased.

Further, in the present embodiment, the interior-side waist seal 3 is also provided, on the outer surface 30b of the mounting base portion 30, with the auxiliary member (the first and second auxiliary members 33 and 34) which is arranged so as to face the inner surface of the tip portion of the seal lip (the first and second seal lips 31 and 32), and with which the tip portion of the seal lip (the first and second seal lips 31 and 32) can come into elastic contact.

As described above, in the present embodiment, similar to the glass run GR, the auxiliary member (the first and second auxiliary members 33 and 34) is disposed also at the interior-side waist seal 3. Therefore, the interior-side waist seal 3 can ensure smooth up-and-down movement of the door glass DG within the allowable variation range R, and can reduce the vibrations (amplitude) of the door glass DG and also quickly damp the vibrations (amplitude) in a range that exceeds the allowable variation range R, by the auxiliary member (the first and second auxiliary members 33 and 34) formed of the dilatant fluid.

Moreover, in the present embodiment, as the auxiliary member, a plurality of first and second auxiliary members 33 and 34 are provided so as to face the first and second seal lips 31 and 32 respectively, and the reaction force F of each of the first and second seal lips 31 and 32 upon being bent and deformed (upon being flexibly deformed) can be adjusted by the first and second auxiliary members 33 and 34. It is therefore possible to ensure smooth up-and-down movement of the door glass DG without significantly increasing the sliding resistance (the sliding drag) of the door glass DG, by each of the auxiliary members 33 and 34. On the other hand, for an input that causes the displacement of the door glass DG to exceed the allowable variation range R which is the range due to vehicle variations, the dilatant fluid constituting each of the auxiliary members 33 and 34 instantaneously hardens. Therefore, the reaction force F of each of the auxiliary members 33 and 34 is instantly increased, thereby effectively reducing the vibrations (amplitude) of the door glass DG and also quickly damping the vibrations (amplitude).

### Modified Example

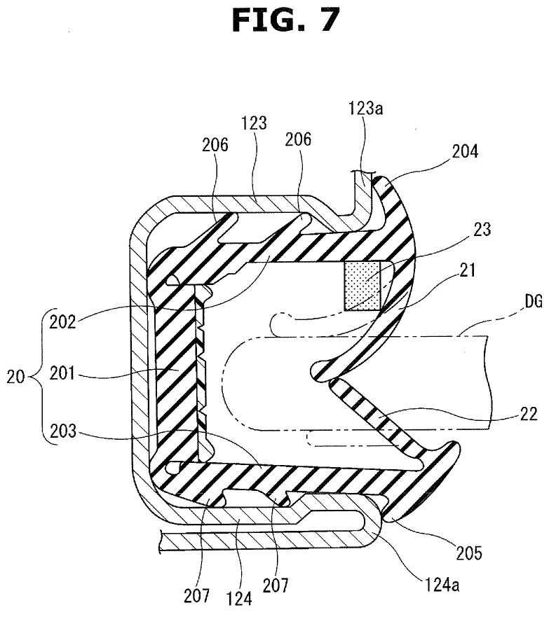

FIGS. 7 to 9 show a modified example of the first embodiment of the glass run according to the present invention. In this modified example, an arrangement of the auxiliary member 23 is mainly changed, and the other configurations are the same as those of the first embodiment. Therefore, the same elements or components as those of the first embodiment are denoted by the same reference symbols, and their detailed description will be omitted.

### Configuration of Glass Run

FIG. 7 is a cross-sectional view of the vertical side portion 121 of the glass run 2 according to the modified example of the first embodiment of the present invention, which is cut along an A-A line of FIG. 1.

As illustrated in FIG. 7, the glass run GR according to the present modified example is provided with the auxiliary member 23 formed of the dilatant fluid and having a substantially rectangular cross-sectional surface, at a position, where a root portion of the interior-side seal lip 21 can abut against the auxiliary member 23 when the interior-side seal lip 21 is bent and deformed to the interior side, on the inner surface of the interior-side side wall portion 202. Here, regarding a detailed configuration of the auxiliary member 23, similar to the first embodiment, as a matter of course, any cross-sectional shape of the auxiliary member 23 can be adopted according to specifications of the glass run 2 (for instance, a shape of the interior-side seal lip 21, reaction force characteristics required of the auxiliary member 23, etc.). Furthermore, the auxiliary member 23 could be formed integrally with the interior-side side wall portion 202 by extrusion molding, or the auxiliary member 23 may be fixed to the interior-side side wall portion 202 by a fixing means such as vulcanization adhesion.

### Working and Effect of the Present Modified Example

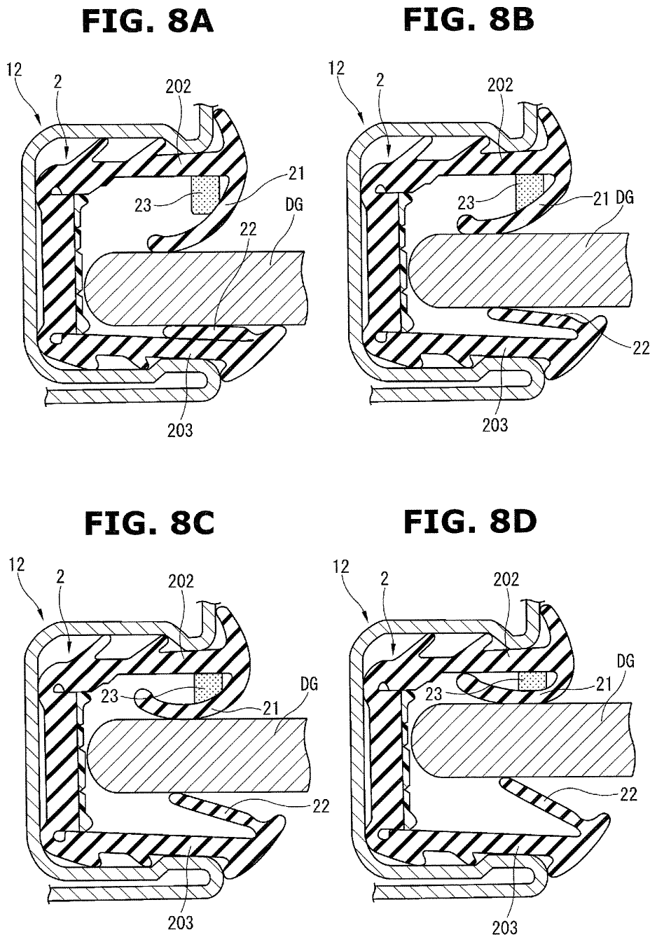

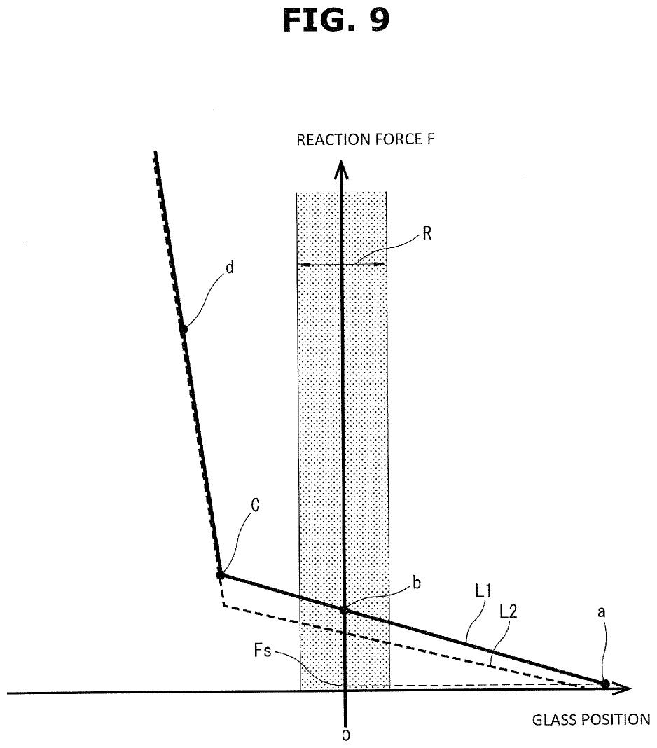

FIGS. 8A to 8D are cross-sectional views showing states of the glass run GR according to the present modified example when the door glass DG vibrates. FIG. 8A shows a state in which the door glass DG is located closest to the exterior side in the vehicle width direction. FIG. 8B shows a state in which the door glass DG is located at a center of the allowable variation range R in the vehicle width direction. FIG. 8C shows a state in which the door glass DG is located closest to the interior side within the allowable variation range R in the vehicle width direction. FIG. 8D shows a state in which the door glass DG is located closest to the interior side in the vehicle width direction. FIG. 9 is a graph showing reaction force characteristics of the glass run GR according to the present modified example. A point a indicates the state of FIG. 8A, a point b indicates the state of FIG. 8B, a point c indicates the state of FIG. 8C, and a point d indicates the state of FIG. 8D. Here, the allowable variation range R shown in FIG. 9 indicates a range that can allow (tolerate) variations in the door glass DG when the door glass DG moves up and down, including manufacturing errors and installation errors of the door glass DG. Furthermore, a solid line L1 shown in FIG. 9 indicates reaction force characteristics of the interior-side seal lip 21 according to the present modified example. A virtual line L2 indicates reaction force characteristics of the interior-side seal lip 21 in a state in which the auxiliary member 23 is not added.

As illustrated in FIGS. 8A to 8D, the glass run GR according to the present modified example supports the door glass DG by the auxiliary member 23 formed of the dilatant fluid. Therefore, as illustrated in FIG. 9, within the allowable range R of variation due to vehicle variations (the point a to the point c in FIG. 9), the dilatant fluid that constitutes the auxiliary member 23 flexibly deforms. As a result, there is no risk that the sliding resistance (the sliding drag) of the door glass DG will excessively increase. Accordingly, smooth up-and-down movement of the door glass DG can be ensured. On the other hand, for a large (fast) input that causes the displacement of the door glass DG to exceed the allowable variation range R (the point d in FIG. 9), the dilatant fluid constituting the auxiliary member 23 instantaneously hardens, thereby instantly increasing the reaction force F of the interior-side seal lip 21. It is therefore possible to reduce the vibrations (amplitude) of the door glass DG.

As described above, similar to the first embodiment, the glass run GR according to the present modified example, also, can ensure smooth up-and-down movement of the door glass DG within the allowable variation range R, and can reduce the vibrations (amplitude) of the door glass DG and also quickly damp the vibrations (amplitude) in response to a large (fast) input that exceeds the allowable variation range R, by the auxiliary member 23 formed of the dilatant fluid.

In addition, in the present modified example, as illustrated in FIG. 8, the auxiliary member 23 is provided on the inner surface of the interior-side side wall portion 202, and when the interior-side seal lip 21 is bent and deformed toward the interior side, the root portion of the interior-side seal lip 21 abuts against the auxiliary member 23.

With this configuration, in a state in which the door glass DG is located closest to the exterior side, the interior-side seal lip 21 abuts against the auxiliary member 23, thereby increasing an initial reaction force Fs of the interior-side seal lip 21. On the other hand, for a small (gentle) input when the door glass DG moves up and down, the dilatant fluid constituting the auxiliary member 23 flexibly deforms, thereby ensuring smooth up-and-down movement of the door glass DG. Therefore, it is possible to suppress initial movement of the door glass DG when the door glass DG vibrates, without scarifying the smooth up-and-down movement of the door glass DG, and to effectively reduce the vibrations (amplitude) of the door glass DG.

### Second Embodiment

### Configuration of Glass Run

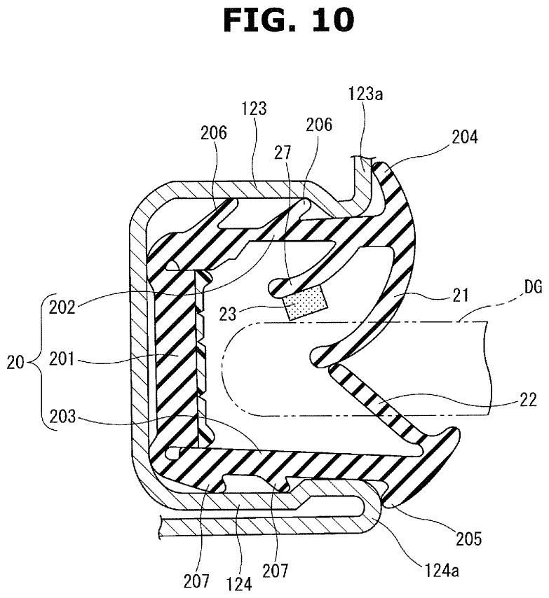

FIGS. 10 to 13 illustrate a second embodiment of the glass run according to the present invention. In the present embodiment, a sub lip 27 is added, and the auxiliary member 23 is disposed at the sub lip 27. The other configurations are the same as those of the first embodiment. Therefore, the same elements or components as those of the first embodiment are denoted by the same reference symbols, and their detailed description will be omitted.

FIG. 10 is a cross-sectional view of the vertical side portion 121 of the glass run 2 according to the second embodiment of the present invention, which is cut along an A-A line of FIG. 1.

As illustrated in FIG. 10, the glass run GR according to the present embodiment is provided, on the inner surface of the interior-side side wall portion 202, with the sub lip 27 which assists in supporting sliding-contact of the interior-side seal lip 21 with the door glass DG, by coming into elastic contact with the inner surface of the tip portion of the interior-side seal lip 21 which has been pushed to the interior side by the door glass DG when the door glass DG is raised.

Furthermore, the glass run GR according to the present embodiment is provided, on an outer surface of a tip portion of the sub lip 27, with the auxiliary member 23 formed of the same dilatant fluid as the first embodiment and having a substantially rectangular cross-sectional surface. Here, also in the present embodiment, regarding a detailed configuration of the auxiliary member 23, similar to the first embodiment, as a matter of course, any cross-sectional shape of the auxiliary member 23 can be adopted according to specifications of the glass run 2 (for instance, a shape of the interior-side seal lip 21, reaction force characteristics required of the auxiliary member 23, etc.). Furthermore, the auxiliary member 23 could be formed integrally with the sub lip 27 by extrusion molding, or the auxiliary member 23 may be fixed to the sub lip 27 by a fixing means such as vulcanization adhesion.

### Configuration of Waist Seal

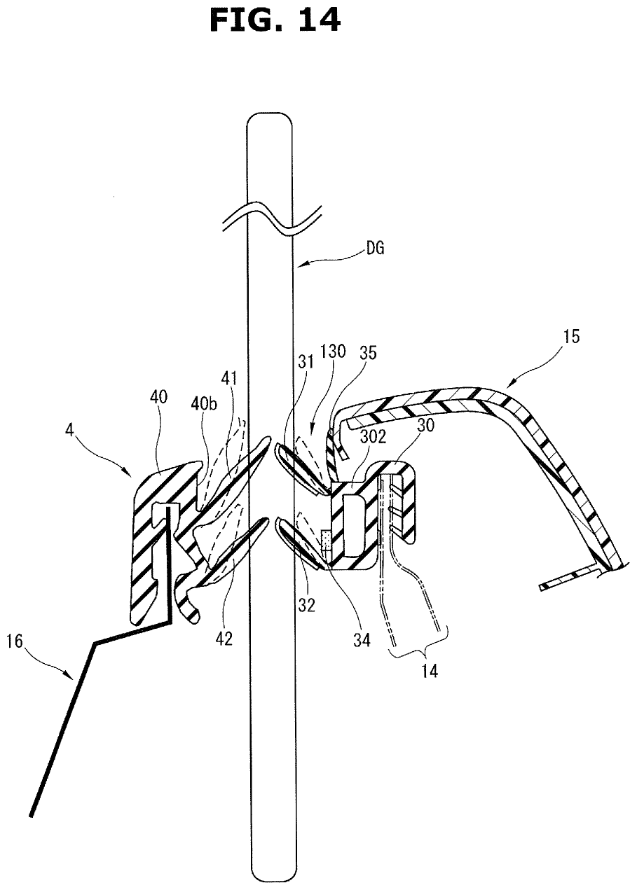

FIG. 14 illustrates a second embodiment of the waist seal according to the present invention. In the present embodiment, a configuration of the mounting base portion 30 is mainly changed, and the other configurations are the same as those of the first embodiment. Therefore, the same elements or components as those of the first embodiment are denoted by the same reference symbols, and their detailed description will be omitted.

FIG. 14 is a cross-sectional view showing the second embodiment of the waist seal (the interior-side waist seal 3) according to the present invention, which is cut along a B-B line of FIG. 1.

As illustrated in FIG. 14, in the present embodiment, the mounting base portion 30 of the interior-side waist seal 3 is formed of a hard solid rubber-based material such as EPDM. The mounting base portion 30 has an inverted U-shaped cross section, and is attached to the door inner panel 14 by sandwiching an upper end portion of the door inner panel 14.

Further, in the present embodiment, the mounting base portion 30 is provided, at an exterior side thereof, with a seal base portion 302 that extends in a hollow shape along a longitudinal direction of the mounting base portion 30. This seal base portion 302 is provided, on an exterior-side side surface thereof, with a pair of first and second seal lips 31 and 32 that are formed in two upper and lower stages and protrude substantially parallel to each other. These seal lips 31 and 32 are formed integrally with the seal base portion 302. The first seal lip 31 is provided at an upper end portion on an outer surface of the seal base portion 302, whereas the second seal lip 32 is provided at a lower end portion on the outer surface of the seal base portion 302.

Furthermore, in the present embodiment, the seal base portion 302 is provided, at an exterior-side end portion of the upper end portion thereof, with a sub lip 35 which extends upward and whose tip portion can elastically contact the door trim 15. The sub lip 35 is formed integrally with the seal base portion 302. That is, the sub lip 35 comes into elastic contact with the door trim 15, then a gap between the door inner panel 14 and the door trim 15 is sealed.

Moreover, in the present embodiment, on the exterior side of the seal base portion 302, the first auxiliary member 33 of the first embodiment, which can come into elastic contact with the first seal lip 31, is removed, and only the second auxiliary member 34 which can come into elastic contact with the second seal lip 32 is provided. Here, also in the present embodiment, regarding a detailed configuration of the second auxiliary member 34, similar to the first embodiment, as a matter of course, any cross-sectional shape of the second auxiliary member 34 can be adopted according to specifications of the waist seal 3 (for instance, a shape of the second seal lip 32, reaction force characteristics required of the second auxiliary member 34, etc.). Furthermore, the second auxiliary member 34 could be formed integrally with the seal base portion 302 by extrusion molding, or the second auxiliary member 34 may be fixed to the seal base portion 302 by a fixing means such as vulcanization adhesion.

On the other hand, with regard to the first seal lip 31, instead of the first auxiliary member 33 being removed, the first seal lip 31 is structured so as to be able to abut against a middle portion of the sub lip 35 that is pushed out toward the exterior side by the elastic contact with the door trim 15. That is, when the door glass DG is significantly displaced to the interior side, e.g. upon vibration of the door glass DG, and the first seal lip 31 is significantly bent and deformed, the first seal lip 31 and the sub lip 35 cooperate with each other for supporting the door glass DG, thereby suppressing rattle of the door glass DG. In other words, to suppress the vibration of the door glass DG, the interior-side waist seal 3 may be configured so that one of the plurality of seal lips 31 and 32 is supported by the sub lip 35, and the other is supported by the auxiliary member (for instance, the second auxiliary member 34).

### Working and Effect of the Present Embodiment

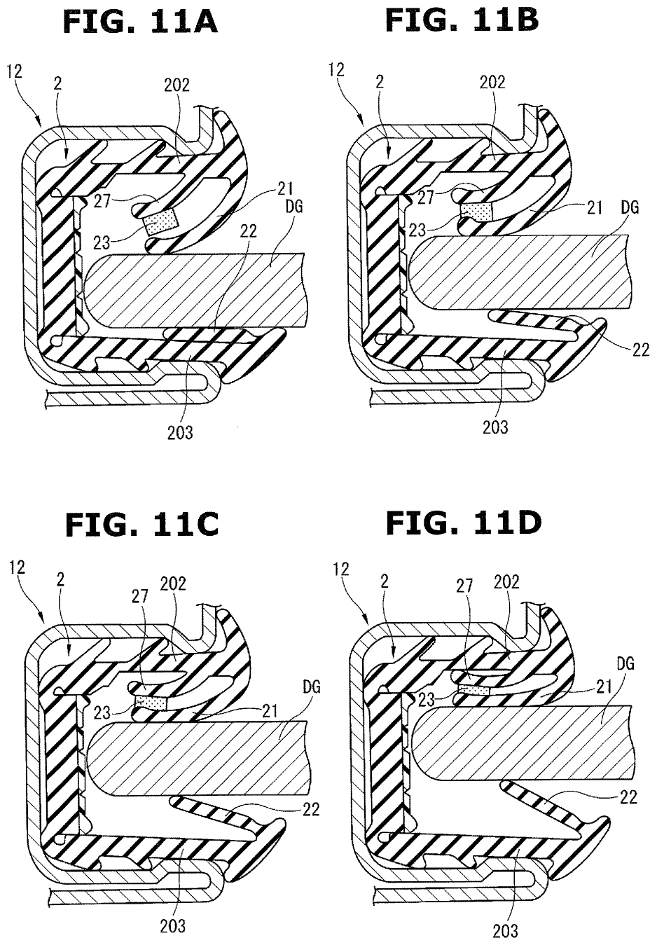

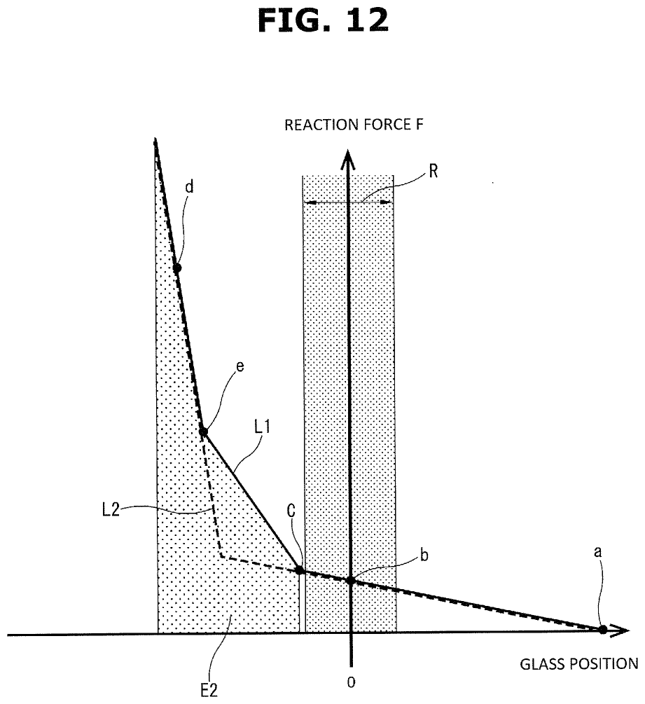

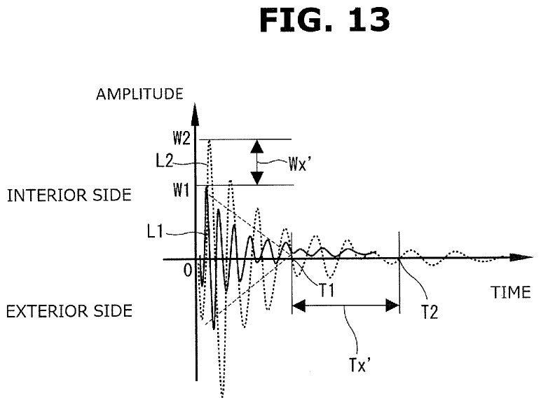

FIGS. 11A to 11D are cross-sectional views showing states of the glass run GR according to the present embodiment when the door glass DG vibrates. FIG. 11A shows a state in which the door glass DG is located closest to the exterior side in the vehicle width direction. FIG. 11B shows a state in which the door glass DG is located at a center of the allowable variation range R in the vehicle width direction. FIG. 11C shows a state in which the door glass DG is located closest to the interior side within the allowable variation range R in the vehicle width direction. FIG. 11D shows a state in which the door glass DG is located closest to the interior side in the vehicle width direction. FIG. 12 is a graph showing reaction force characteristics of the glass run GR according to the present embodiment. A point a indicates the state of FIG. 11A, a point b indicates the state of FIG. 11B, a point c indicates the state of FIG. 11C, and a point d indicates the state of FIG. 11D. Here, the allowable variation range R shown in FIG. 12 indicates a range that can allow (tolerate) variations in the door glass DG when the door glass DG moves up and down, including manufacturing errors and installation errors of the door glass DG. Furthermore, a solid line L1 shown in FIG. 12 indicates reaction force characteristics of the interior-side seal lip 21 according to the present embodiment. A virtual line L2 indicates reaction force characteristics of the interior-side seal lip 21 in a state in which the auxiliary member 23 is not added. FIG. 13 is a graph showing amplitude and attenuation characteristics of the glass run GR shown in FIG. 10. A solid line L1 shown in FIG. 13 indicates attenuation characteristics of the interior-side seal lip 21 according to the present embodiment. A virtual line L2 indicates attenuation characteristics of the interior-side seal lip 21 in a state in which the auxiliary member 23 is not added.

As illustrated in FIGS. 11A to 11D, the glass run GR according to the present embodiment supports the door glass DG by the auxiliary member 23 made of the dilatant fluid and formed integrally with the sub lip 27. Therefore, as illustrated in FIG. 12, within the allowable range R of variation due to vehicle variations (the point a to the point c in FIG. 12), the dilatant fluid that constitutes the auxiliary member 23 flexibly deforms. As a result, there is no risk that the sliding resistance (the sliding drag) of the door glass DG will excessively increase. Accordingly, smooth up-and-down movement of the door glass DG can be ensured.

On the other hand, for a large (fast) input that causes the displacement of the door glass DG to exceed the allowable variation range R (the point d in FIG. 12), the reaction force F of the interior-side seal lip 21 increases due to bending-deformation of the sub lip 27 (the point c to the point e in FIG. 12), and after the sub lip 27 abuts against the interior-side side wall portion 202, the dilatant fluid constituting the auxiliary member 23 instantaneously hardens, thereby instantly and significantly increasing the reaction force F of the interior-side seal lip 21. As a result, as illustrated in FIG. 13, the glass run GR according to the present embodiment, which is indicated by the solid line L1, can reduce vibrations (amplitude) of the door glass DG by a difference Wx′ between an amplitude W1 of L1 and an amplitude W2 of L2, as compared with the related art glass run GR indicated by the virtual line L2. Furthermore, since the amplitude W1 is reduced, a convergence time T1 of the amplitude W1 can also be shortened by a difference Tx′ between the convergence time T1 of L1 and a convergence time T2 of L2. In particular, in the present embodiment, since the auxiliary member 23 is provided at the sub lip 27, the reaction force F of the sub lip 27 is added to a hardening phenomenon of the auxiliary member 23, thereby increasing the damping characteristic of the door glass DG (Tx>Tx′) as compared with the first embodiment.

As described above, the glass run GR according to the present embodiment, also, can ensure smooth up-and-down movement of the door glass DG within the allowable variation range R, and can reduce the vibrations (amplitude) of the door glass DG and also quickly damp the vibrations (amplitude) in response to a large (fast) input that exceeds the allowable variation range R, by the auxiliary member 23 formed of the dilatant fluid.

In addition, in the present embodiment, the sub lip 27 which extends from the inner surface of the interior-side side wall portion 202 toward the inside of the base portion 20, and against which the interior-side seal lip 21 elastically abuts when the interior-side seal lip 21 is bent and deformed toward the interior side, is further provided. In addition, the auxiliary member 23 is provided on the surface, facing the interior-side seal lip 21, of the sub lip 27, and when the interior-side seal lip 21 is bent and deformed toward the interior side, the interior-side seal lip 21 abuts against the auxiliary member 23.

As described above, by providing the auxiliary member 23 on the opposing surface of the sub lip 27 to the interior-side seal lip 21 and disposing the auxiliary member 23 between the sub lip 27 and the interior-side seal lip 21, it is possible to delay the change in reaction force of the sub lip 27. With this, there is no risk that the reaction force F of the sub lip 27 will significantly increase within the allowable variation range R, thereby ensuring smooth up-and-down movement of the door glass DG.

On the other hand, when a large input that exceeds the allowable variation range R is applied to the interior-side seal lip 21, the dilatant fluid constituting the auxiliary member 23 instantaneously hardens, and the bending-deformation of the interior-side seal lip 21 is directly transmitted to the sub lip 27 via the auxiliary member 23. Therefore, the reaction force F of the sub lip 27 is instantly increased, thereby accelerating the change in the reaction force of the sub lip 27. It is thus possible to reduce the vibrations (amplitude) of the door glass DG and also to quickly damp the vibrations (amplitude).

Additionally, in the present embodiment, since the sub lip 27 is provided at the base portion 20, it is possible to generate the reaction force F by the interior-side seal lip 21 and the sub lip 27. With this, although there is a possibility that the vibrations (amplitude) of the door glass DG will increase by an amount of bending-deformation of the sub lip 27, since the reaction force F of the sub lip 27 acts in addition to the interior-side seal lip 21, the vibrations of the door glass DG can be damped and converged more quickly.

The present invention is not limited to the configurations disclosed in the above embodiments. Specific aspects of the details that are not directly related to the technical features of the present invention, such as material and shape of the base portion 20, the interior-side seal lip 21 and the exterior-side seal lip 22 of the glass run GR, material and shape of mounting base portion 30, the first seal lip 31 and the second seal lip 32 of the interior-side waist seal 3, and material and shape of the mounting base portion 40, the first seal lip 41 and the second seal lip 42 of the exterior-side waist seal 4, can be freely changed according to specifications of the vehicle body to which the present invention is applied, without departing from the scope of the present invention.

### DESCRIPTION OF REFERENCE SYMBOLS

1 . . . door
14 . . . interior-side door panel
15 . . . door trim
16 . . . exterior-side door panel
2 . . . glass run
20 . . . base portion
201 . . . base bottom portion
202 . . . interior-side side wall portion
203 . . . exterior-side side wall portion
21 . . . interior-side seal lip
22 . . . exterior-side seal lip
23 . . . auxiliary member
27 . . . sub lip
3 . . . interior-side waist seal (waist seal)
30 . . . mounting base portion
31 . . . first seal lip
32 . . . second seal lip
33 . . . first auxiliary member
34 . . . second auxiliary member
35 . . . sub lip
4 . . . exterior-side waist seal
DG . . . door glass

1. A glass run comprising:
a base portion having a substantially square bracket-shaped cross section formed by a base bottom portion, an interior-side side wall portion, and an exterior-side side wall portion, both of which extend from both end portions, in a vehicle width direction, of the base bottom portion;
an interior-side seal lip, and an exterior-side seal lip, which extend respective tip portions of both the side wall portions toward an inside of the base portion, and which are provided so as to be able to come into sliding-contact with a door glass that moves up and down inside the base portion along a longitudinal direction of both the side wall portions; and
an auxiliary member which is formed of a dilatant fluid, and against which the interior-side seal lip abuts when the interior-side seal lip is bent and deformed toward an interior side of a vehicle.

2. The glass run as claimed in claim 1,
wherein
the auxiliary member is provided on an inner surface of the interior-side side wall portion, and a tip portion of the interior-side seal lip abuts against the auxiliary member when the interior-side seal lip is bent and deformed toward the interior side.

3. The glass run as claimed in claim 1,
further comprising
a sub lip which is provided at and extends from an inner surface of the interior-side side wall portion toward the inside of the base portion, and against which the interior-side seal lip elastically abuts when the interior-side seal lip is bent and deformed toward the interior side,
wherein the auxiliary member is provided on a surface, which faces the interior-side seal lip, of the sub lip, and the interior-side seal lip abuts against the auxiliary member when the interior-side seal lip is bent and deformed toward the interior side.

4. The glass run as claimed in claim 1,
wherein
the auxiliary member is provided on an inner surface of the interior-side side wall portion, and a root portion of the interior-side seal lip abuts against the auxiliary member when the interior-side seal lip is bent and deformed toward the interior side.

5. A waist seal comprising:
a mounting base portion attached to an interior-side door panel or a door trim that covers the interior-side door panel;
a seal lip provided at and extending from the mounting base portion toward an exterior side of a vehicle, and coming into sliding-contact with a door glass to seal a gap between the interior-side door panel or the door trim and the door glass; and
an auxiliary member formed of a dilatant fluid, and provided on an exterior-side side surface of the mounting base portion so as to face the seal lip, wherein the seal lip abuts against the auxiliary member when the seal lip is bent and deformed toward an interior side of the vehicle.

6. The waist seal as claimed in claim 5,
wherein
a plurality of seal lips are provided on the exterior-side side surface, which faces the door glass, of the mounting base portion along an up-and-down movement direction of the door glass, and
a plurality of auxiliary members are provided so as to face the respective seal lips, and when the seal lips are bent and deformed toward the interior side, the seal lips abut against the auxiliary members.
